(19) United States
(12) Patent Application Publication
(10) Pub. No.: US 2009/0110375 A1
(43) Pub. Date: Apr. 30, 2009

(54) INFORMATION RECORDING DEVICE AND METHOD, AND COMPUTER PROGRAM

(75) Inventors: Yuji Shimizu, Saitama (JP); Yasuyuki Umehara, Saitama (JP); Tadashi Kondo, Saitama (JP); Tatsuo Sasaki, Saitama (JP)

Correspondence Address: YOUNG & THOMPSON, 209 Madison Street, Suite 500, ALEXANDRIA, VA, 22314, US

(73) Assignee: Pioneer Corporation, Tokyo (JP)

(21) Appl. No.: 12/294,166

(22) PCT Filed: Mar. 14, 2007
(86) PCT No.: PCT/JP2007/055058

§ 371 Date: Nov. 6, 2008

(30) Foreign Application Priority Data
Mar. 24, 2006 (JP) 2006-082638

(51) Int. Cl. H04N 5/00

(52) U.S. Cl. 386/126

(57) ABSTRACT

An information recording device is provided with a recording means (300) for recording first contents information on an information recording medium (100), an information acquiring means (467) for acquiring information of a kind or type of the information recording medium and a medium state indicative of a vacant capacity, a first control means (476) for controlling the recording means so as to record the first contents information in (i) a first manner when the medium state is in a first state, and a second control means (476) for controlling the recording means so as to record the second contents information in (ii) a second manner when the medium state is in a second state.

### TECHNICAL FIELD

The present invention relates to an information recording apparatus and method, such as a DVD recorder, and a computer program which makes a computer function as such an information recording apparatus.

### BACKGROUND ART

A magnetic recording medium such as a hard disk, an optical disc such as a CD and a DVD, or the like is heavily used as an information recording medium for recording data. The type of the information recording medium ranges widely, and when the data is recorded, it is necessary to record the data using a disc drive in accordance with the type of the information recording medium.

On the other hand, the data recording is also performed in a user's desired aspect, by converting a data format in accordance with the type of the information recording medium onto which the data is to be recorded. Such a data recording method along with the data format conversion is disclosed in a patent document 1, for example. The patent document 1 discloses a method of recording the data onto a DVD-RAM, a method of converting the data format in recording the data onto the DVD-RAM, and the like.

Patent document 1: Japanese Patent Application Laid Open NO. Hei 11-66736

### DISCLOSURE OF INVENTION

### Subject to be Solved by the Invention

Recently, a combo drive which can support various types of information recording media has increased. The combo drive can record the data onto different types of information recording media (e.g. CD and DVD described above), for example. However, in the case of the combo drive, there is such a technical problem that the method in the patent document 1 or the like described above hardly allows the preferable data recording while converting the format, for example. That is, the method in the patent document 1 or the like described above aims at recording the data onto a particular information recording medium, and when the data is recorded onto the various types of information recording media, there is such a technical problem that a user needs to record the data while successively specifying a desired aspect each time.

In view of the aforementioned problems, it is therefore an object of the present invention to provide an information recording apparatus and method, which can preferably record the data onto various types of information recording media, and a computer program which makes a computer function as such an information recording apparatus.

### Means for Solving the Subject

(Information Recording Apparatus)

The above object of the present invention can be achieved by an information recording apparatus provided with: a recording device for recording at least first content information onto an information recording medium; an obtaining device for obtaining a medium condition which indicates at least a type and a free space of the information recording medium; a first controlling device for (i) controlling the recording device to record the first content information in a first aspect, if the medium condition obtained by the obtaining device is a first condition; and a second controlling device for (ii) controlling the recording device to record the first content information in a second aspect, which is different from the first aspect, if the medium condition obtained by the obtaining device is a second condition, which is different from a first condition.

According to the information recording apparatus of the present invention, by the operation of the recording device, the first content information, including various information such as video information and audio information, is recorded onto the information recording medium.

The recording operation of the recording device will be explained specifically. By the operation of the obtaining device, the medium condition is obtained, which indicates the type and the free space (in other words, a recording capacity in which the information can be recorded) of the information recording medium or the like. In accordance with the obtained medium condition, the aspect of recording the first content information is changed, as occasion demands. Specifically, if the obtained medium condition is the first condition, the recording device is controlled by the operation of the first controlling device to record the first content information onto the information recording medium in the first aspect. On the other hand, if the obtained medium condition is the second condition, the recording device is controlled by the operation of the second controlling device to record the first content information onto the information recording medium in the second aspect.

As explained above, according to the information recording apparatus of the present invention, it is possible to change the aspect of recording the first content information in accordance with the medium condition, as occasion demands. Thus, it is possible to record the first content information in a more preferable aspect, in accordance with the medium condition of the information recording medium. That is, even if a user does not successively give an instruction in accordance with the medium condition of the information recording medium, it is possible to record the first content information, in the aspect according to the medium condition of the information recording medium (in other words, in the desired aspect), so-called automatically. As described above, it is possible to preferably record the data onto the various types of information recording media.

In one aspect of the information recording apparatus of the present invention, it is further provided with a presenting device for presenting that the first content information cannot be recorded, if the medium condition obtained by the obtaining device is not the first condition nor the second condition.

According to this aspect, if the medium condition is not the first condition nor the second condition (i.e. is the condition in which the control of the recording device by the first controlling device and the second controlling device is not performed), a warning indicating that the first content information cannot be recorded can be presented to a user.

In another aspect of the information recording apparatus of the present invention, the first condition is a condition in which (i) the type is a first type (e.g. DVD) and (ii) the free space is greater than or equal to a sum of sizes of the first content information (e.g. JPEG data) and second content information (e.g. slideshow data using the JPEG data), which is generated by converting the first content information into a predetermined format (e.g. a slideshow format complying with a DVD-VIDEO format) corresponding to the first type, the second condition is a condition in which (ii) the type is a first type and (ii) the free space is less than the sum of the sizes of the first content information and the second content information, and is greater than or equal to the size of the first content information, or a condition in which (i) the type is a second type (e.g. CD) which is different from the first type and (ii) the free space is greater than or equal to the size of the first content information, the first controlling device controls the recording device to record the second content information in addition to the first content information, as the first aspect, and the second controlling device controls the recording device to record the first content information, as the second aspect.

According to this aspect, it is possible to record the first content information in a more preferable aspect, in accordance with the medium condition of the information recording medium.

In this aspect, it may be further provided with a presenting device for presenting that the first content information cannot be recorded, if the free space is less than the size of the first content information.

By virtue of such construction, a warning indicating that the first content information cannot be recorded can be presented to a user.

In this aspect, the information recording medium of the first type may be a DVD, the information recording medium of the second type may be a CD, and the predetermined format may be a slideshow format complying with a DVD format.

According to this aspect, it is possible to record an image and a slideshow onto the information recording medium, if the first content information is the image or in similar cases.

In another aspect of the information recording apparatus of the present invention, the medium condition indicates whether or not a status of the information recording medium is a recordable condition, each of the first condition and the second condition is a condition in which the status is the recordable condition, and the information recording apparatus is further provided with a presenting device for presenting that the first content information cannot be recorded, if the status is not the recordable condition.

In this aspect, if the first content information cannot be recorded due to the status of the information recording medium (e.g. information from which it is judged whether or not the condition is a recordable condition, such as whether or not a close process, a finalizing process, or the like is performed), a warning indicating that the first content information cannot be recorded can be presented to a user.

(Information Recording Method)

The above object of the present invention can be also achieved by an information recording method in an information recording apparatus provided with: a recording device for recording at least first content information onto an information recording medium, the information recording method provided with: an obtaining process of obtaining a medium condition which indicates at least a type and a free space of the information recording medium; a first controlling process of (i) controlling the recording device to record the first content information in a first aspect, if the medium condition obtained by the obtaining device is a first condition; and a second controlling process of (ii) controlling the recording device to record the first content information in a second aspect, which is different from the first aspect, if the medium condition obtained by the obtaining device is a second condition, which is different from a first condition.

According to the information recording method of the present invention, it is possible to receive the same various benefits as those of the information recording apparatus of the present invention described above.

Incidentally, in response to the various aspects of the information recording apparatus of the present invention described above, the information recording method of the present invention can also adopt various aspects.

(Computer Program)

The above object of the present invention can be also achieved by a computer program for recording control to control a computer provided for the aforementioned information recording apparatus of the present invention (including its various aspects), the computer program making the computer function as at least one portion of the obtaining device, the first controlling device, and the second controlling device.

According to the computer program of the present invention, the aforementioned information recording apparatus of the present invention can be embodied relatively readily, by loading the computer program from a recording medium for storing the computer program, such as a ROM, a CD-ROM, a DVD-ROM, a hard disk or the like, into the computer, or by downloading the computer program, which may be a carrier wave, into the computer via a communication device.

Incidentally, in response to the various aspects of the information recording apparatus of the present invention described above, the computer program of the present invention can adopt various aspects.

The above object of the present invention can be also achieved by a computer program product in a computer-readable medium for tangibly embodying a program of instructions executable by a computer provided for the aforementioned information recording apparatus of the present invention (including its various aspects), the computer program product making the computer function as at least one portion of the obtaining device, the first controlling device, and the second controlling device.

According to the computer program product of the present invention, the aforementioned information recording apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information recording apparatus of the present invention.

These effects and other advantages of the present invention will become more apparent from the embodiment explained below.

As explained above, according to the information recording apparatus of the present invention, it is provided with the recording device, the obtaining device, the first controlling device, and the second controlling device. According to the information recording method of the present invention, it is provided with the obtaining process, the first controlling process, and the second controlling process. According to the computer program of the present invention, it makes a computer function as at least one portion of the obtaining device, the first controlling device, and the second controlling device. Therefore, it is possible to preferably record the data onto the various types of information recording media.

### BRIEF DESCRIPTION OF DRAWINGS

FIG. 1 is a block diagram conceptually showing the basic structure of an information recording/reproducing apparatus in an embodiment.

FIG. 2 is a block diagram conceptually showing the basic structure of a disc drive of the information recording/reproducing apparatus in the embodiment.

FIG. 3 is a block diagram conceptually showing the basic structure of a host computer of the information recording/reproducing apparatus in the embodiment.

FIG. 4 is a first flowchart conceptually showing a flow of the recording operation of the information recording/reproducing apparatus in the embodiment.

FIG. 5 is a second flowchart conceptually showing a flow of the recording operation of the information recording/reproducing apparatus in the embodiment.

FIG. 6 is a first explanatory diagram conceptually showing data to be recorded onto an optical disc.

FIG. 7 is a second explanatory diagram conceptually showing data to be recorded onto an optical disc.

FIG. 8 is a plan view conceptually showing a warning screen.

FIG. 9 is a third flowchart conceptually showing a flow of the recording operation of the information recording/reproducing apparatus in the embodiment.

### DESCRIPTION OF REFERENCE CODES

100 optical disc
200 information recording/reproducing apparatus
300 disc drive
400 host computer
476 CPU

### BEST MODE FOR CARRYING OUT THE INVENTION

Hereinafter, the best mode for carrying out the present invention will be explained in each embodiment in order with reference to the drawings.

(1) Basic Structure

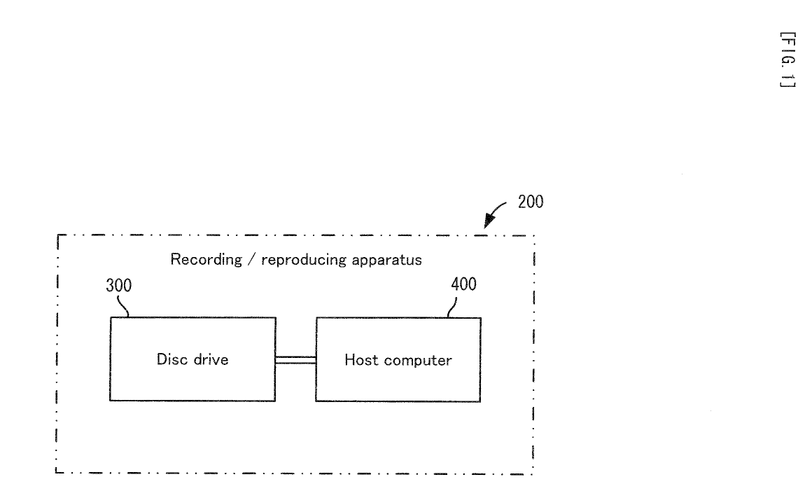

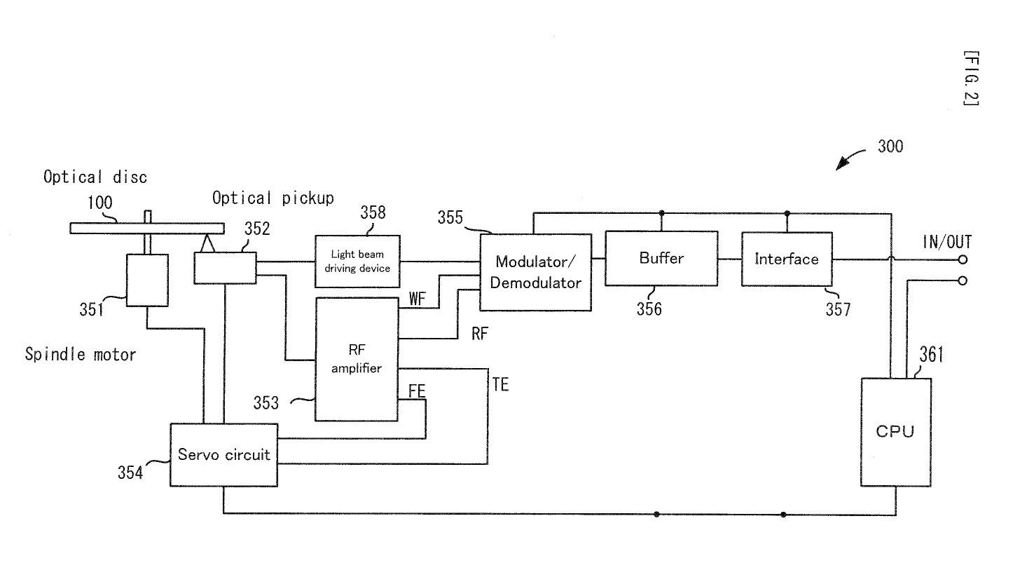

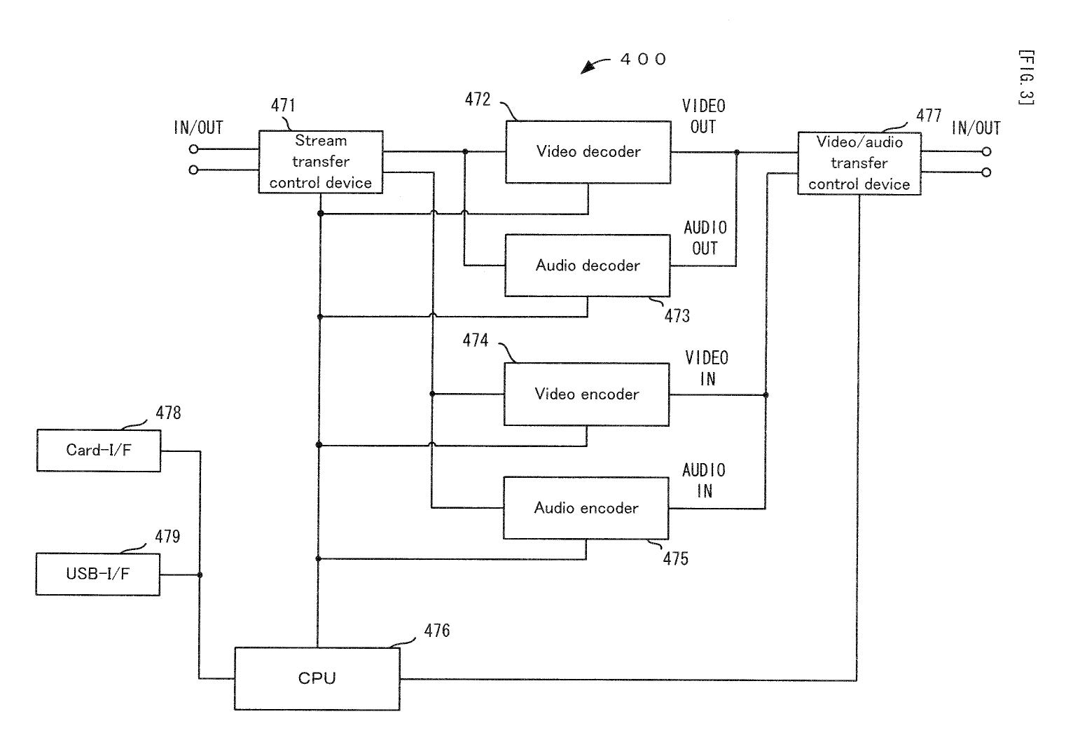

Firstly, with reference to FIG. 1 to FIG. 3, an explanation will be given on an information recording/reproducing apparatus 200 as an example of the information recording apparatus of the present invention. FIG. 1 is a block diagram conceptually showing the basic structure of the information recording/reproducing apparatus 200 in an embodiment. FIG. 2 is a block diagram conceptually showing the basic structure of a disc drive 300 of the information recording/reproducing apparatus 200 in the embodiment. FIG. 3 is a block diagram conceptually showing the basic structure of a host computer 400 of the information recording/reproducing apparatus 200 in the embodiment. Incidentally, the information recording/reproducing apparatus 200 has a function of recording data onto an optical disc 100 and a function of reproducing the data recorded on the optical disc 100.

As shown in FIG. 1, the information recording/reproducing apparatus 200 is provided with: the disc drive 300 on which the optical disc 100 is actually loaded and on which data recording and data reproduction is performed; and the host computer 400, such as a personal computer, for controlling the data recording and reproduction with respect to the disc drive 300.

As shown in FIG. 2, the disc drive 300 constitutes one specific example of the “recording device” of the present invention. The disc drive 300 is provided with: a spindle motor 351; an optical pickup 352; a RF amplifier 353; a servo circuit 354; a modulator/demodulator 355; a buffer 356; an interface 357; a light beam driving device 358; and a CPU 361.

The spindle motor 351 is intended to rotate and stop the optical disc 100, and operates in accessing the optical disc 100. More specifically, the spindle motor 351 is adapted to rotate the optical disc 100 at a predetermined speed and stop it, under spindle servo by the spindle circuit 354.

The optical pickup 352 is an apparatus for irradiating a recording surface of the optical disc 100 with a light beam to thereby record the data onto the recording surface and for receiving reflected light of the light beam to thereby read the record data recorded on the recording surface. Specifically, the optical pickup 352 is provided with a semiconductor laser apparatus, a collimator lens, an objective lens or the like, which are not illustrated. Moreover, the optical pickup 352 irradiates the optical disc 100 with a light beam as reading light with a first power upon reproduction, and as writing light with a second power with it modulated upon recording. Then, the optical pickup 352 outputs a RF signal corresponding to the reflective light of the light beam.

The RF amplifier 353 amplifies the RF signal outputted from the optical pickup 352, and outputs the RF signal to the modulator/demodulator 355. Moreover, the RF amplifier 353 generates a wobble frequency signal WF, a tracking error signal TE, and a focus error signal FE from the RF signal, and outputs them.

The servo circuit 354 is a servo control circuit for controlling the drive of the spindle motor 351 and the optical pickup 352, on the basis of the tracking error signal TE, the focus error signal FE, and other servo control signals.

The modulator/demodulator 355 is a circuit provided with a function of performing error correction on the data in the reading and a function of appending an error correction code to the data and of modulating this in the recording. Specifically, in the reading, the modulator/demodulator 355 demodulates the RF signal outputted from the RF amplifier 353, performs the error correction on this, and then outputs this to the buffer 356. Moreover, in the recording, the modulator/demodulator 355 appends the error correction code to the data outputted from the buffer 356, modulates this to be a code suitable for optical property of the optical disc 100, and then outputs the modulated data to the light beam driving device 358.

The buffer 356 is a memory circuit for temporarily storing the data.

The interface 357 is a circuit for performing input/output control or communication control of the record data or the like between the disc drive 300 and the host computer 400. Specifically, the interface 357 outputs the data outputted from the buffer 356 (i.e. the data read from the optical disc 100) to the host computer 400, in accordance with a request command from the host computer 400, in the reproduction. Moreover, the interface 357 receives the data to be inputted to the disc drive 300 from the host computer 400 and outputs this to the buffer 356, in the recording.

The light beam driving device 358 generates a light beam driving signal corresponding to the data outputted from the modulator/demodulator 355 and outputs this to the optical pickup 352, in the recording. The optical pickup 352 modulates the light beam on the basis of the light beam driving signal and irradiates the recording surface of the optical disc 100 with it. By this, the data is recorded onto the recording surface.

The CPU 361 controls the entire disc drive 300 and controls the exchange of the information between elements in the disc drive 300 described above. Moreover, the CPU 361 controls a data recording operation and a data reading operation. Moreover, the CPU 361 controls the exchange of the data between the disc drive 300 and the host computer 400, in accordance with a control command or a request command sent from the host computer 400.

As shown in FIG. 3, the host computer 400 is provided with: a stream transfer control device 471; a video decoder 472; an audio decoder 473; a video encoder 474; an audio encoder 475; a CPU 476; a video/audio transfer control device 477; a card-I/F (Interface) 478; and a USB-I/F (Universal Serial Bus Interface) 479.

The stream transfer control device 471 is a circuit for controlling a process of transferring a video stream and an audio stream to the disc drive 300. An operation of reading and reproducing the data from the optical disc 100 and an operation of receiving the data from the exterior and of recording it onto the optical disc 100 are performed by cooperation of the disc drive 300 and the host computer 400.

Each of the video decoder 472 and the audio decoder 473 is a circuit for decoding the data (in other words, a stream signal) which is read from the optical disc 100 by the disc drive 300 and which is supplied through the stream transfer control device 471, and for converting the decoded data into a reproducible condition by a display, a speaker, or the like.

Each of the video encoder 474 and the audio encoder 475 is a circuit for receiving a video signal, an audio signal, or the like inputted from the exterior in order to be recorded onto the optical disc 100, for encoding the signal in a MPEG compression method or the like to thereby convert it to the stream signal, and for supplying this to the disc drive 300 through the stream transfer control device 471.

The CPU 476 is a circuit for controlling the stream transfer control device 471, the video decoder 472, and the audio decoder 473 and for performing the data reproduction process in cooperation with them, in the reproduction. Moreover, the CPU 476 controls the stream transfer control device 471, the video encoder 474, the audio encoder 475 and for performing the data recording process in cooperation with them, in the recording. Moreover, the CPU 476 performs control on the disc drive 300 (e.g. generation and transmission of various request commands, reception of a reply signal, and the like), in order to realize the cooperation of the disc drive 300 and the host computer 400, in the reproduction and the recording.

The video/audio transfer control device 477 controls the output of the video signal and the audio signal to the exterior and controls the input of the video signal and the audio signal from the exterior.

The card-I/F (Interface) 478 performs the input/output of the data between the host computer 400 and a card-type semiconductor memory, such as a memory card, a memory stick, and a SD card. The data inputted through the card-I/F (Interface) 478 can be recorded onto the optical disc 100, same as the data inputted from the video/audio transfer control device 477. In the same manner, the data recorded on the optical disc 100 can be outputted to the exterior through the card-I/F (Interface) 478, same as the data outputted from the video/audio transfer control device 477.

The USB-I/F (Interface) 479 performs the input/output of the data between the host computer 400 and external equipment, such as a digital camera. The data inputted through the USB-I/F (Interface) 479, can be recorded onto the optical disc 100, same as the data inputted from the video/audio transfer control device 477. In the same manner, the data recorded on the optical disc 100 can be outputted to the exterior through the USB-I/F (Interface) 479, as in the data outputted from the video/audio transfer control device 477.

One specific example in which the disc drive 300 and the host computer 400, as explained above, are used together is household equipment, such as recorder equipment for recording/reproducing a video. The recorder equipment records a video signal from a broadcast reception tuner and an external connection terminal, onto a disc, and outputs the video signal reproduced from the disc, to external display equipment, such as a television. The operation as the recorder equipment is performed by executing a program stored in the memory 360, on the CPU 359. Moreover, in another specific example, the disc drive 300 is a disc drive (hereinafter referred to as a drive, as occasion demands), and the host computer 400 is a personal computer or a workstation. The host computer 400, such as the personal computer, and the disc drive are connected to each other through the data input/output control devices 306 and 308, such as the SCSI and the ATAPI. An application, such as writing software, which is installed in the host computer 400, controls the disc drive 300.

(2) Operation Principle

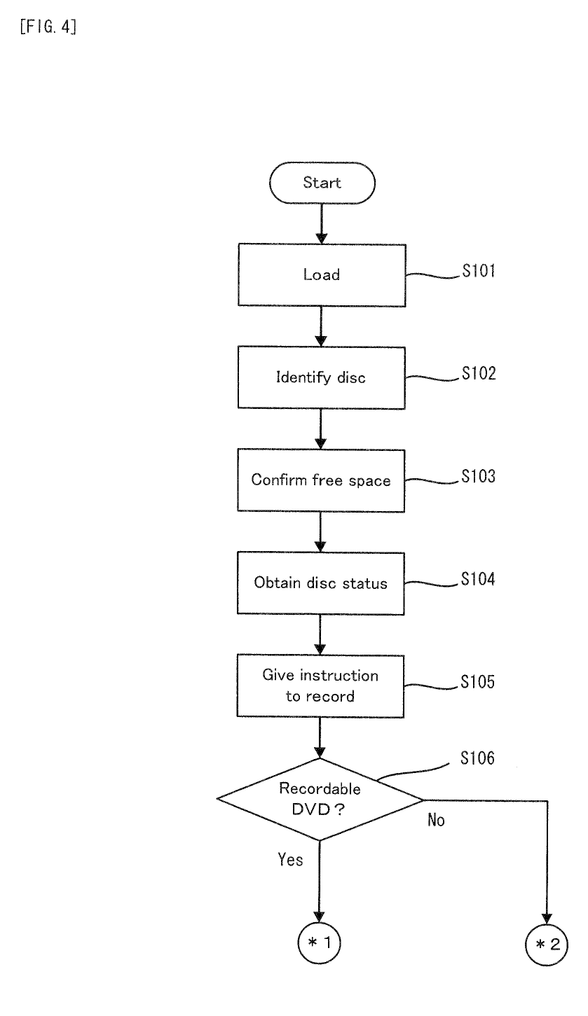

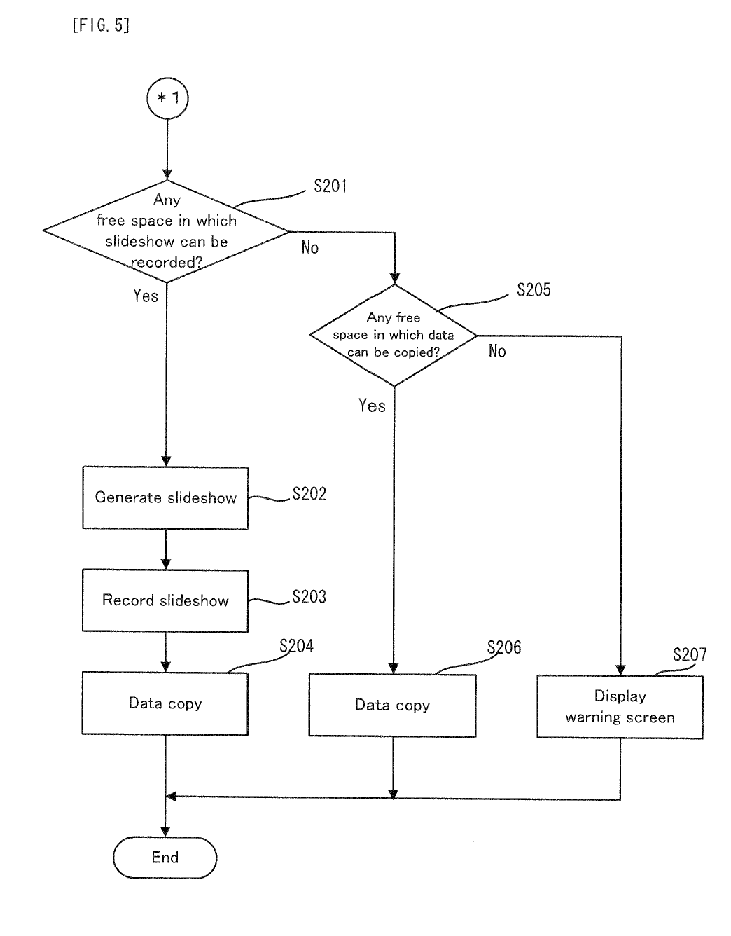

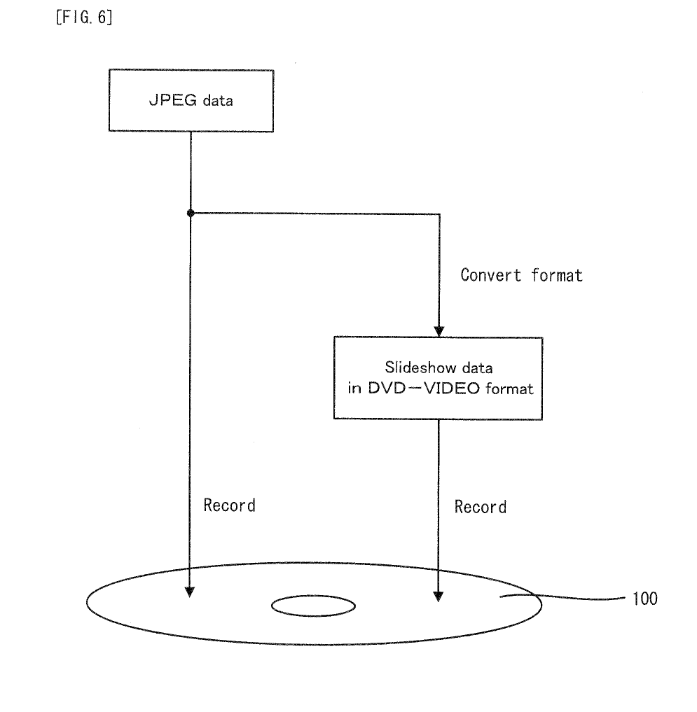

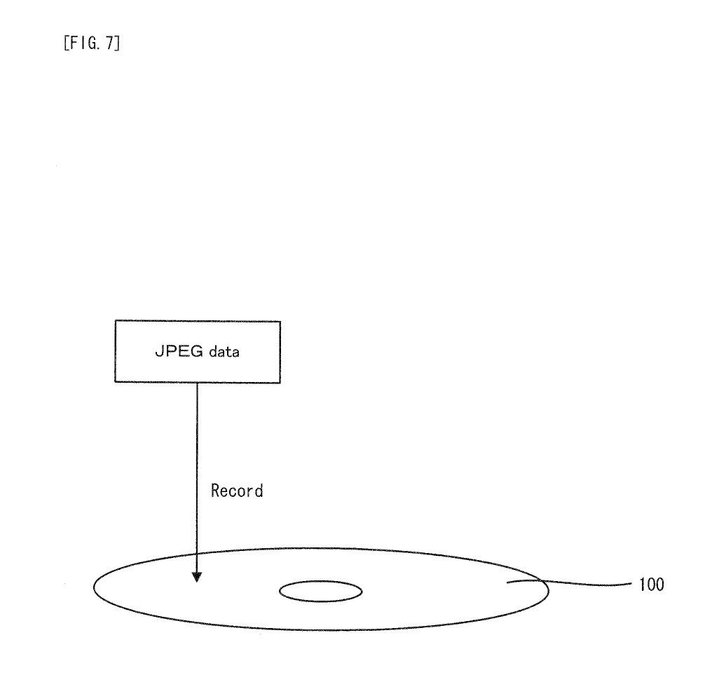

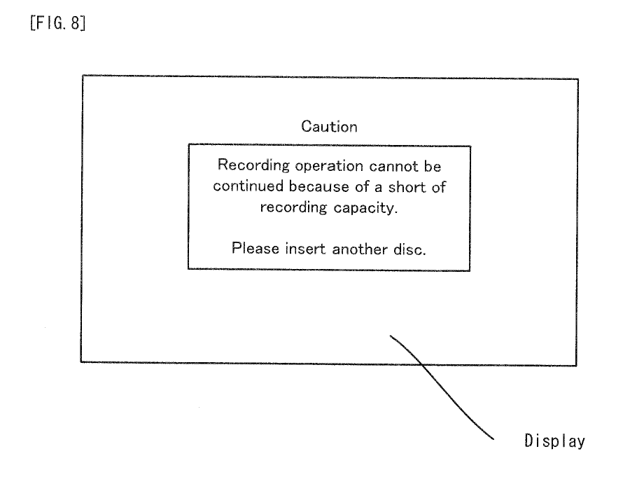

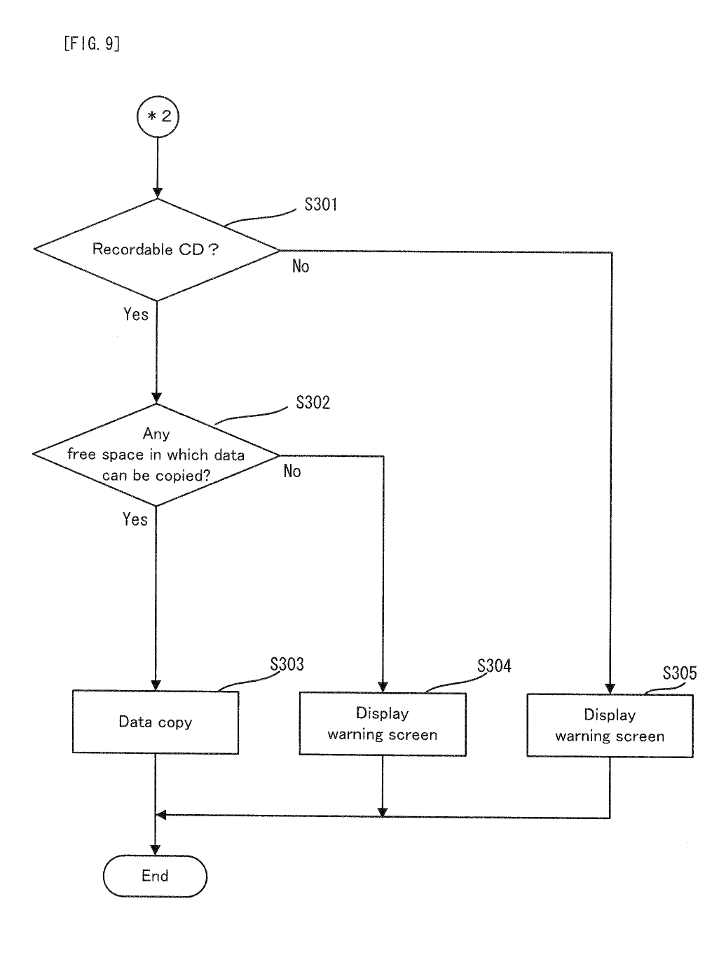

Next, with reference to FIG. 4 to FIG. 9, an explanation will be given on the operation principle of the recording operation of the information recording/reproducing apparatus 200 in the embodiment. FIG. 4 is a first flowchart conceptually showing a flow of the recording operation of the information recording/reproducing apparatus 200 in the embodiment. FIG. 5 is a second flowchart conceptually showing a flow of the recording operation of the information recording/reproducing apparatus 200 in the embodiment. FIG. 6 is a first explanatory diagram conceptually showing the data to be recorded onto the optical disc 100. FIG. 7 is a second explanatory diagram conceptually showing the data to be recorded onto the optical disc 100. FIG. 8 is a plan view conceptually showing a warning screen. FIG. 9 is a third flowchart conceptually showing a flow of the recording operation of the information recording/reproducing apparatus 200 in the embodiment.

Incidentally, in the explanation below, as the recording operation of the information recording/reproducing apparatus 200, an operation of recording a JPEG image data onto the optical disc 100 is taken as an example. Such an operation is performed when the JPEG image data, which is recorded by a digital camera or the like on a semiconductor memory, such as a memory card and a SD card, is backed-up or dubbed (or copied) on the optical disc 100, such as a CD an a DVD, through the card-I/F (Interface) 478 or the like.

As shown in FIG. 4, firstly, the optical disc 100 is loaded on the disc drive 300 (step S101).

Then, under the control of the CPU 476, which constitutes one specific example of the “obtaining device” of the present invention, the type of the loaded optical disc 100 is identified (step S102). For example, it is identified whether the loaded optical disc 100 is a read-only type CD-ROM, a recordable-type CD-R/RW, a read-only type DVD-ROM, a recordable-type DVD-R/RW, or another type of optical disc (e.g. Blu-ray Disc, HD DVD, or the like).

Moreover, under the control of the CPU 476, which constitutes one specific example of the “obtaining device” of the present invention, the free space (i.e. the size of an area in which the data can be recorded) of the loaded optical disc 100 is obtained (step S103).

Moreover, under the control of the CPU 476, which constitutes one specific example of the “obtaining device” of the present invention, the disc status of the loaded optical disc 100 is obtained (step S104). Specifically, the disc status which indicates whether the optical disc 100 is in the data recordable condition or not (specifically, for example, a close process or finalizing process is performed) is obtained.

Then, under the control of the CPU 476, the JPEG image data recorded on the semiconductor memory is inputted to the host computer 400 through the card-I/F, and the actual recording (i.e. backup or dubbing (or copying)) of the JPEG image data onto the optical disc 100 is performed (step S105).

Then, it is judged whether or not the loaded optical disc 100 is a data-recordable DVD, on the basis of the type of the optical disc 100 identified in the step S102, the free space of the optical disc 100 obtained in the step S103, and the disc status of the optical disc 100 obtained in the step S104 (step S106). That is, if the loaded optical disc 100 is any one of a DVD-R, DVD-RW, DVD+R, DVD+RW, and DVD-RAM and if the loaded optical disc 100 is in the data recordable condition, then it is judged that it is the data recordable DVD. On the other hand, if the loaded optical disc 100 is not any one of a DVD-R, DVD-RW, DVD+R, DVD+RW, and DVD-RAM or if the loaded optical disc 100 is not in the data recordable condition, then it is judged that it is not the data recordable DVD.

As a result of the judgment in the step S106, if it is judged that it is the data recordable DVD (the step S106: Yes), the operational flow goes to a step shown by “*1” in the flowchart in FIG. 5, and the recording operation is continued.

On the other hand, as a result of the judgment in the step S106, if it is judged not to be the data recordable DVD (the step S106: No), the operational flow goes to a step shown by “*2” in the flowchart in FIG. 5, and the recording operation is continued.

Then, as shown in FIG. 5, under the control of the CPU 476, it is judged whether or not the loaded optical disc 100 has a free space in which each of the JPEG image data and slideshow data using the JPEG image data can be recorded (step S201). In other words, it is judged whether or not the free space of the loaded optical disc 100 is greater than or equal to the sum of the data sizes of the JPEG image data and the slideshow data using the JPEG image data.

As a result of the judgment in the step S201, if it is judged that the loaded optical disc 100 has the free space in which each of the JPEG image data and the slideshow data using the JPEG image data can be recorded (the step S201: Yes), the slideshow data is generated using the JPEG image data, under the control of the CPU 476, which constitutes one specific example of the “first controlling device” of the present invention (step S202). The slideshow data complies with a DVD-VIDEO format or a DVD-VR format, and is data in which the JPEG image data is displayed in order, or randomly at fixed time intervals, or at random time intervals. Moreover, the slideshow data is also data in which predetermined or a user's desired music is outputted in accordance with the display of the JPEG image data.

Then, under the control of the CPU 476, which constitutes one specific example of the “first controlling device” of the present invention, the slideshow data generated in the step S202 is recorded onto the optical disc 100 (step S203). Moreover, under the control of the CPU 476, which constitutes one specific example of the “first controlling device” of the present invention, the JPEG image data is recorded onto the optical disc 100 (step S204).

In this case, as shown in FIG. 6, the JPEG image data recorded in the semiconductor memory or the like and the slideshow data generated by using the JPEG image data are recorded onto the optical disc 100.

Moreover, the processes in the step S202 and the step S203 are sometimes performed in parallel, such that the slideshow data is generated in real time or a temporal memory area to store the slideshow data is insufficient. That is, the slideshow data is continuously generated in the process in the step S202; however, the operation of recording the slideshow data is repeated by the process in the step S203 when a certain size of slideshow data is prepared by the process in the step S202. When the generation of the slideshow data is completed and the recording of the slideshow data is ended, then the recording of the slideshow data onto the optical disc 100 is completed.

On the other hand, as a result of the judgment in the step S201, if it is judged that the loaded optical disc 100 does not have the free space in which each of the JPEG image data and the slideshow data using the JPEG image data can be recorded (the step S201: No), then, under the control of the CPU 476, it is judged whether or not the loaded optical disc 100 has a free space in which the JPEG image data can be recorded (step S205).

As a result of the judgment in the step S205, if it is judged that the loaded optical disc 100 has the free space in which the JPEG image data can be recorded (the step S205: Yes), under the control of the CPU 476, which constitutes one specific example of the “second controlling device” of the present invention, the JPEG image data is recorded onto the optical disc 100 (step S206).

In this case, as shown in FIG. 7, the JPEG image data recorded in the semiconductor memory or the like is recorded onto the optical disc 100, and the aforementioned slideshow data is not recorded.

On the other hand, as a result of the judgment in the step S205, if it is judged that the loaded optical disc 100 does not have the free space in which the JPEG image data can be recorded (the step S205: No), under the control of the CPU 476, which constitutes one specific example of the “presenting device” of the present invention, a warning screen which indicates that the JPEG image data cannot be recorded onto the optical disc 100 is displayed on a display, for example (step S207).

In this case, in the optical disc 100, the JPEG image data recorded in the semiconductor memory or the like is not recorded, and the warning screen as shown in FIG. 8 is displayed on the display or the like. Of course, in addition to or instead of the warning screen, a warning by audio may be made, or a warning may be made by the lighting of a lamp on a display panel or the like.

Then, as show in FIG. 9, as a result of the judgment in the step S106 in FIG. 4, if it is judged that it is not the data recordable DVD (the step S106: No), it is judged whether or not the loaded optical disc 100 is a data-recordable CD, on the basis of the type of the optical disc 100 identified in the step S102, the free space of the optical disc 100 obtained in the step S103, and the disc status of the optical disc 100 obtained in the step S104 (step S301). That is, if the loaded optical disc 100 is any one of a CD-R and CD-RW and if the loaded optical disc 100 is in the data recordable condition, then it is judged that it is the data recordable CD. On the other hand, if the loaded optical disc 100 is not any one of a CD-R and CD-RW or if the loaded optical disc 100 is not in the data recordable condition, then it is judged that it is not the data recordable CD.

As a result of the judgment in the step S301, if it is judged that it is the data recordable CD (the step S301: Yes), then, under the control of the CPU 476, it is judged whether or not the loaded optical disc 100 has a free space in which the JPEG image data can be recorded (step S302).

As a result of the judgment in the step S302, if it is judged that the loaded optical disc 100 has the free space in which the JPEG image data can be recorded (the step S302: Yes), under the control of the CPU 476, which constitutes one specific example of the “second controlling device” of the present invention, the JPEG image data is recorded onto the optical disc 100 (step S303).

In this case, as shown in FIG. 7, the JPEG image data recorded in the semiconductor memory or the like is recorded onto the optical disc 100, and the aforementioned slideshow data is not recorded.

On the other hand, as a result of the judgment in the step S302, if it is judged that the loaded optical disc 100 does not have the free space in which the JPEG image data can be recorded (the step S302: No), under the control of the CPU 476, which constitutes one specific example of the “presenting device” of the present invention, a warning screen which indicates that the JPEG image data cannot be recorded onto the optical disc 100 is displayed on a display, for example (step S304).

In this case, in the optical disc 100, the JPEG image data recorded in the semiconductor memory or the like is not recorded, and the warning screen as shown in FIG. 8 is displayed on the display or the like.

On the other hand, as a result of the judgment in the step S301, if it is judged that it is not the data recordable CD (the step S301: No), a warning screen which indicates that the JPEG image data cannot be recorded onto the optical disc 100 is displayed on a display, for example (step S305).

As explained above, according to the information recording/reproducing apparatus 200 in the embodiment, it is possible to change the data recording aspect, as occasion demands, in accordance with the type, free space, disc status or the like of the optical disc 100. For example, if the optical disc 100 has the sufficient free space, not only the data but also the data obtained by converting the data format and data type or the like are also recorded. If the optical disc 100 has a certain degree of free space, the data is recorded. If the optical disc 100 does not have the free space or if the data cannot be recorded onto the optical disc 100, a warning statement is displayed, instead of the data recording. Thus, in accordance with the loaded optical disc 100, it is possible to record the data in a more preferable aspect. That is, even if a user does not successively give an instruction in accordance with the type, free space, disc status or the like of the optical disc 100 every time the optical disc 100 is loaded, it is possible to record the data in an aspect according to the type, free space, disc status or the like of the optical disc 100 (in other words, the user's desired aspect), so-called automatically. As described above, it is possible to preferably record the data onto the optical disc 100 of various types.

Incidentally, in the aforementioned embodiment, the JPEG image data is taken as one specific example of the data recorded onto the optical disc 100; however, the aforementioned operations may be performed even if the data except the JPEG image data is recorded onto the optical disc 100. Similarly, regarding the slideshow data, the aforementioned operations may be performed even in the data except the slideshow data; for example, data obtained by converting the data to be originally recorded onto the optical disc 100 in some method, or other data. The point is that the aforementioned various benefits can be received as long as the data recording aspect can be changed, as occasion demands, in accordance with the condition of the recording medium onto which the data is to be recorded (more preferably, as long as the data recording aspect can be changed to be suited to the condition of the recording medium).

Incidentally, in the above-mentioned embodiment, the optical disc 100 is explained as one example of the information recording medium, and the recorder related to the optical disc 100 is explained as one example of the information recording apparatus. The present invention, however, is not limited to the optical disc and the recorder thereof, and can be applied to other various information recording media which support high-density recording or a high transfer rate, and recorders thereof.

The present invention is not limited to the aforementioned embodiment, but various changes may be made, if desired, without departing from the essence or spirit of the invention which can be read from the claims and the entire specification. An information recording apparatus and method, and a computer program, all of which involve such changes, are also intended to be within the technical scope of the present invention.

### INDUSTRIAL APPLICABILITY

The information recording apparatus and method, and the computer program according to the present invention can be applied to an information recording apparatus, such as a DVD recorder. Moreover, they can be applied to an information recording apparatus or the like which is mounted on various computer equipment for consumer use or for commercial use, or which can be connected to various computer equipment.

1. An information recording apparatus comprising:
a recording device for recording at least first content information onto an information recording medium;
an obtaining device for obtaining a medium condition which indicates at least a type and a free space of the information recording medium;
a first controlling device for (i) controlling said recording device to record the first content information in a first aspect, if the medium condition obtained by said obtaining device is a first condition; and
a second controlling device for (ii) controlling said recording device to record the first content information in a second aspect, which is different from the first aspect, if the medium condition obtained by said obtaining device is a second condition, which is different from a first condition, wherein
the first condition is a condition in which (i) the type is a first type and (ii) the free space is greater than or equal to a sum of sizes of the first content information and second content information, which is generated by converting the first content information into a predetermined format corresponding to the first type,
the second condition is a condition in which (i) the type is a first type and (ii) the free space is less than the sum of the sizes of the first content information and the second content information, and is greater than or equal to the size of the first content information, or a condition in which (i) the type is a second type which is different from the first type and (ii) the free space is greater than or equal to the size of the first content information,
said first controlling device controls said recording device to record the second content information in addition to the first content information, as the first aspect, and
said second controlling device controls said recording device to record the first content information, as the second aspect.

2. The information recording apparatus according to claim 1, further comprising a presenting device for presenting that the first content information cannot be recorded, if the medium condition obtained by said obtaining device is not the first condition nor the second condition.

3. (canceled)

4. The information recording apparatus according to claim 1, further comprising a presenting device for presenting that the first content information cannot be recorded, if the free space is less than the size of the first content information.

5. The information recording apparatus according to claim 1, wherein
the information recording medium of the first type is a DVD,
the information recording medium of the second type is a CD, and
the predetermined format is a slideshow format complying with a DVD format.

6. The information recording apparatus according to claim 1, wherein
the medium condition indicates whether or not a status of the information recording medium is a recordable condition,
each of the first condition and the second condition is a condition in which the status is the recordable condition, and
the information recording apparatus further comprises a presenting device for presenting that the first content information cannot be recorded, if the status is not the recordable condition.

7. An information recording method in an information recording apparatus comprising: a recording device for recording at least first content information onto an information recording medium,
said information recording method comprising:
an obtaining process of obtaining a medium condition which indicates at least a type and a free space of the information recording medium;
a first controlling process of (i) controlling said recording device to record the first content information in a first aspect, if the medium condition obtained by said obtaining process is a first condition; and
a second controlling process of (ii) controlling said recording device to record the first content information in a second aspect, which is different from the first aspect, if the medium condition obtained by said obtaining process is a second condition, which is different from a first condition, wherein
the first condition is a condition in which (i) the type is a first type and (ii) the free space is greater than or equal to a sum of sizes of the first content information and second content information, which is generated by converting the first content information into a predetermined format corresponding to the first type,
the second condition is a condition in which (i) the type is a first type and (ii) the free space is less than the sum of the sizes of the first content information and the second content information, and is greater than or equal to the size of the first content information, or a condition in which (i) the type is a second type which is different from the first type and (ii) the free space is greater than or equal to the size of the first content information,
said first controlling process controls said recording device to record the second content information in addition to the first content information, as the first aspect, and
said second controlling process controls said recording device to record the first content information, as the second aspect.

8. A computer program product in a computer-readable medium for tangibly embodying a program of instructions executable by a computer provided for the information recording apparatus according to claim 1, said computer program making the computer function as at least one portion of said obtaining device, said first controlling device, and said second controlling device.
